(19) United States
(12) Patent Application Publication
(10) Pub. No.: US 2020/0113019 A1
(43) Pub. Date: Apr. 9, 2020

(54) ELECTRIC HEATING DEVICE

(71) Applicant: Webasto SE, Stockdorf (DE)

(72) Inventors: MARTIN ZOSKE, Stockdorf (DE); VOLODYMYR ILCHENKO, Stockdorf (DE); UWE STRECKER, Stockdorf (DE); BENGT MEIER, Stockdorf (DE); NIKOLAUS GERHARDT, Stockdorf (DE); MICHAEL SCHWANECKE, Stockdorf (DE)

(21) Appl. No.: 16/615,742

(22) PCT Filed: May 23, 2018
(86) PCT No.: PCT/EP2018/063513

§ 371 Date: Nov. 21, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 060.1

(51) Int. Cl. H05B 3/14; F24H 1/10; F24H 1/20; F24H 1/12; F24H 3/04

(52) U.S. Cl. CPC H05B 3/146; F24H 1/103; F24H 1/202; H05B 2203/021; F24H 3/0429; F24H 2250/04; H05B 2203/02; F24H 1/121

(57) ABSTRACT

An electric heating apparatus, in particular a liquid or air heating apparatus, in particular for a motor vehicle, including a first heating element and at least one second heating element. The heating elements comprise in each case one, in particular insulating, substrate and one polymer layer which contains a polymer component and a conductive component, in particular a carbon component. An intermediate space through which the fluid is capable of passing for heating said fluid is configured between the heating elements. The heating elements are connected to one another by one or a plurality of, in particular conductive, spacer(s) disposed therebetween, and/or one or more, in particular conductive, positioning element(s) that penetrate (a) respective clearance(s) and/or openings of the heating elements.

### CROSS-REFERENCE TO RELATED APPLICATIONS

This application represents the national stage entry of PCT International Patent Application No. PCT/EP2018/063513 filed on May 23, 2018 and claims priority to German Patent Application No. DE 10 2017 111 373.8 filed May 24, 2017, and German Patent Application No. DE 10 2017 111 378.9 filed May 24, 2017. The contents of each of these applications are hereby incorporated by reference as if set forth in their entirety herein.

### DESCRIPTION

The disclosure relates to an electric heating apparatus, in particular for a motor vehicle, to a method for producing an electric heating apparatus, to a kit for producing a heating apparatus, to a method for operating a heating apparatus, as well as to a use of a heating apparatus.

Electric heating apparatuses (in particular such which are used in mobile applications) are often based on ceramic heating elements having an electrical resistance which is comparatively highly temperature-dependent and by way of which regulating the dispensed heat in a self-acting manner is enabled. Said resistors are usually positive temperature coefficient (PTC) elements. Said PTC elements are typically connected to heat transmission faces from aluminium sheet and are also electrically contacted by way of the latter. A PTC element comprises a PTC resistor, thus a temperature-dependent resistor having a positive temperature coefficient which conducts the electric current more readily at low temperatures than at high temperatures.

Disadvantageous in the case of conventional heating apparatuses having ceramic PTC elements is inter alia the complex production of the latter by virtue of a comparatively complicated fabrication of the heat exchanger and the complex installation of the ceramic elements, sorting of the ceramic elements usually required by virtue of production tolerances, a comparatively unfavourable power density in a heating element/heat exchanger composite on account of a localized generation of heat, a comparatively high restriction in terms of a maximum heating output on account of a thickness of the PTC material (by virtue of a limited heat discharge from the ceramics), as well as a comparatively high risk of shorting in particular by virtue of a minor geometric spacing of components having a high voltage potential.

It is an object of the disclosure to propose a heating apparatus, in particular a liquid or air heating apparatus, which enables efficient heating of the fluid. A high power density in a comparatively minor installation space is to be enabled in particular. It is furthermore an object of the disclosure to propose a corresponding method for producing a heating apparatus, in particular a liquid or air heating apparatus; a corresponding kit for producing a heating apparatus, in particular a liquid or air heating apparatus; a corresponding method for operating a heating apparatus, in particular a liquid or air heating apparatus; as well as a corresponding use of a heating apparatus.

This object is in particular achieved by an electric heating apparatus, in particular a liquid or air heating apparatus, according to Claim 1.

The object is in particular achieved by an electric heating apparatus, in particular a liquid or air heating apparatus, preferably for a vehicle, furthermore preferably for a motor vehicle, comprising a first heating element and at least one second heating element, wherein the heating elements have in each case one, in particular insulating, substrate and one polymer layer, wherein the polymer layer contains a polymer component and a conductive component, in particular a carbon component, wherein an intermediate space through which fluid is capable of passing for heating said fluid is configured between the heating elements, wherein the heating elements are connected to one another by, in particular conductive, spacers disposed therebetween, and/or, in particular conductive, positioning elements (guiding elements) that penetrate the (individual) heating elements (or penetrate (a) respective clearance(s) and/or opening(s) of the respective heating elements).

A core concept of the disclosure lies in that at least two heating elements which have at least one (conductive) polymer layer and are capable of being connected in a modular manner, in particular by way of corresponding (conductive) spacers and/or (conductive) positioning elements (such as, in particular, positioning or guiding pins, respectively), are provided. On account of a modular construction of this type, the individual heating elements can in particular be conceived as a (pure) parallel circuit and adapted in a modular manner in terms of the output (in particular extended in terms of the output of said heating elements). Furthermore, simple contacting of the individual heating elements, or providing the latter with power, respectively, is possible. Overall, a high power density in an existing installation space is achieved by using the heating elements (in particular when thin heat transmission lamellae are used), and a comparatively large effective heat transmission face is provided. No additional safety elements for monitoring the temperature are required in particular when the heating elements display a PTC behaviour.

The (electrically conductive) polymer layer is preferably printed onto the (respective) substrate. Furthermore, electrodes for the contacting of the polymer layer, or supplying power to the latter, respectively, can likewise be printed (onto the substrate and/or the polymer layer).

The (respective) spacer can be conceived as a (for example strip-shaped or rod-shaped, respectively) pad (contact pad) and optionally ensure the power supply as well as guarantee a spacing between the heating elements. To this extent, the spacer can have a double function which enables a simple overall construction of the electric heating apparatus. Spacers of dissimilar sizes (in particular thicknesses) can optionally be provided such that a spacing between the heating elements can be chosen in a variable manner so as to in particular prevent electrical shorting (discharging) and/or so as to set in a targeted manner a pressure loss (of the fluid flowing therethrough).

The (respective) positioning element (guiding element) can in particular be a positioning pin (guiding pin) (for example round, oval, quadrangular, in particular rectangular, preferably square in terms of the cross section) which optionally ensures an equalization of production tolerances (in the sense of guiding or positioning, respectively, the individual heating elements) as well as it enables any optionally required contacting (power supply). Here too, various functions are again implemented by way of one element.

At least two, or precisely two, positioning elements (guiding pins) can preferably run through at least one or a plurality of or all heating elements. On account thereof, the position of the heating elements can be established in a simple manner.

A lacquer coating or sealing of the polymer layer (or parts thereof) can be present as a protection in relation to mechanical damage, moisture, and/or short circuits.

The heating elements are preferably stackable (on top of one another). Furthermore, the heating elements can be embodied as an (overall) parallel-circuit resistor (on account of which stacking on top of one another is in particular enabled).

A first and/or a second heating element preferably extend(s) (at least substantially) along a fluid flow direction. Heating of the fluid can be performed in an effective manner on account thereof. Alternatively or additionally, the heating elements can extend at an angle in relation to the air flow direction, for example at an angle of less than or equal to 90⁰ and more than 0⁰, in particular more than 100.

In embodiments, at least three, preferably at least five, heating elements (having corresponding intermediate spaces) can be provided.

A diameter of the intermediate space between the first and the second heating element is preferably larger than a thickness of the first and/or the second heating element.

The conductive component, in particular the carbon component, can be present in particle form and/or as a (carbon) structure.

The conductive component can comprise metal particles and/or fibres.

Furthermore, the carbon component can be present in the form of carbon black and/or graphite and/or graphene and/or carbon fibres and/or carbon nanotubes and/or fullerenes.

Furthermore, the polymer component can be configured in the form of an electrically insulating polymer component and/or comprise a first polymer sub-component based on ethylene acetate or ethylene acetate copolymer and/or ethylene acrylate or ethylene acrylate copolymer, and/or a second polymer sub-component based on polyolefin, in particular polyethylene and/or polypropylene, and/or polyester and/or polyamide and/or fluoropolymer. The polymer component can also be configured completely (or indeed only in part) from the first or the second polymer sub-component.

In one specific embodiment, the polymer layer forms a PTC resistor.

The heating elements are preferably electrically wired in parallel.

The spacers can be an, in particular integral, component part of the heating elements.

The object mentioned above furthermore comprises a method for producing an electric heating apparatus, in particular a liquid or air heating apparatus, in particular of the type above, comprising a first heating element and at least one second heating element, wherein the heating elements having in each case one, in particular insulating, substrate and one polymer layer, wherein the polymer layer contains a polymer component and a conductive (filler) component, in particular a carbon component, wherein an intermediate space through which fluid is capable of passing for heating said fluid is configured between the heating elements, wherein the heating elements are stacked on top of one another. In the context of the stacking, or as an independent alternative, in particular conductive spacers between the heating elements can mutually space apart the heating elements. Alternatively or additionally thereto, (in particular conductive) positioning or guiding elements, respectively, can run through (be guided through) the heating elements.

Spacers of dissimilar sizes are preferably provided and at least one spacer of a specific (desired) size is selected from said spacers, said spacer of a specific (desired) size then being disposed between the heating elements in a corresponding manner. Alternatively or additionally, guiding elements of dissimilar sizes can be provided and at least one guiding element of a specific (desired or suitable, respectively) size can be selected from said guiding elements and be guided through the heating elements in a corresponding manner. Various requirements can then be met, for example a spacing between the heating elements can be chosen in a variable manner so as to in particular prevent an electrical short circuit (discharging) and/or to set in a targeted manner a pressure loss (of the fluid flowing therethrough).

The positioning elements (guiding elements or guiding pins, respectively) preferably run through the heating elements in the sense that the heating elements have corresponding breakthroughs (holes) which enclose the corresponding positioning element. The breakthroughs (holes) herein can have a cross section that corresponds to the external circumference of the position elements (for example angular, in particular quadrangular, preferably rectangular, furthermore preferably square and/or oval, in particular elliptic, preferably round (so as to be circular)).

The polymer layer and/or at least one electrical connector element is/are preferably imprinted.

The object mentioned above is furthermore achieved by a kit for producing a heating apparatus, in particular a liquid or air heating apparatus, in particular of the type above, comprising a multiplicity of heating elements, wherein the heating elements have in each case one, in particular insulating, substrate and one polymer layer, wherein the polymer layer contains a polymer component and a conductive component, in particular a carbon component, wherein an intermediate space through which fluid can flow for heating said fluid is capable of being configured between the heating elements, wherein the heating elements are capable of being connected to one another in a modular manner such that a second number of heating elements (larger than or equal to 1) can be added to or removed from a first number of heating elements that are connected to one another. This is preferably performed by means of, in particular conductive, spacers that are capable of being disposed (are disposed) between the heating elements, and/or by means of, in particular conductive, positioning elements that penetrate the (individual) heating elements.

The kit preferably comprises spacers and/or positioning elements of dissimilar sizes, in particular spacers of dissimilar thicknesses and/or positioning elements of dissimilar lengths.

The object mentioned above is furthermore achieved by a method for operating a heating apparatus, in particular a liquid or air heating apparatus, of the type above, or produced by the method of the type above, or produced with the kit above, wherein fluid, in particular a liquid, for example water (in particular cooling water), or air flows through the at least one intermediate space and is heated herein.

The object mentioned above is furthermore achieved by the use of a heating apparatus of the type above, or produced according to a method of the type above, or produced with the kit above, for heating fluid, in particular a liquid, such as for example water (in particular cooling water) or air, in particular in a vehicle, preferably in a motor vehicle, furthermore preferably for a motor vehicle interior space.

In embodiments, the polymer component can have a first polymer sub-component based on ethylene acetate (copolymer) and/or ethylene acrylate (copolymer) and/or a second polymer sub-component based on polyolefin, in particular polyethylene and/or polypropylene, and/or polyester and/or polyamide and/or fluoropolymer. The term “sub-component” here is to be used in particular for differentiating between a first and a second polymer sub-component. The respective sub-component can configure the polymer component either in part or else completely. The ethylene acrylate can be ethyl-methyl-acrylate or ethylene-ethyl-acrylate. The ethylene acetate can be ethylene vinyl acetate. The polyethylene can be HD (high density) polyethylene, MD (medium density) polyethylene, LD (low-density) polyethylene. The fluoropolymer can be PFA (copolymer from tetrafluoroethylene and perfluoro propyl vinyl ester), MFA (copolymer from tetrafluoroethylene and perfluoro vinyl ester), FEP (copolymer from tetrafluoroethylene and hexafluoropropylene), ETFE (copolymer from ethylene and tetrafluoroethylene), or PVDF (polyvinylidene fluoride).

In embodiments, the first polymer sub-component can be configured as described in WO 2014/188190 A1 (as a first electrically insulating material). The second polymer sub-component can likewise be configured as described in WO 2014/188190 A1 (as a second electrically insulating material).

The substrate preferably serves as a heat exchanger.

An overall larger (actively) heatable surface can be implemented on account of the polymer layer, on account of which a required surface temperature can be lowered with the overall heating output and the overall installation space remaining the same. At (maximum) surface temperatures of, for example, below 200° C., comparatively high overall heating outputs are nevertheless still possible.

The polymer layer can be applied to (printed onto) the substrate by a coating and/or printing method. A curing step at an elevated temperature (of above 120° C., for example) can optionally be performed in an oven. A screen-printing method or else a squeegee action can be used in the application, for example.

In general, the polymer layer, or a paste used in the production of the polymer layer, respectively, can be configured as described in DE 689 23 455 T2. This applies in particular also to the production and/or the specific composition of said polymer layer or paste, respectively. For example, this also applies to potential binding agents (in particular according to p. 4, para. 2 and p. 5, para. 1 of DE 689 23 455 T2) and/or solvents (in particular according to p. 5, para. 2 and p. 6, para. 2 of DE 689 23 455 T2).

The substrate, or the substrates, respectively, can at least in portions, preferably completely, be made from plastics material, in particular a polymer such as, for example, polyether ketone and/or polyamide. A production from polyethylene (PE) and/or polypropylene (PP) and/or polyether ether ketone (PEEK) and/or (short) fibre-reinforced polyamide (for example, GFRPA) is particularly preferable.

The substrate can be made from an electrically insulating material. An electrically insulating material is in particular understood to be a material which at room temperature (25° C.) has an electrical conductivity of less than 10⁻¹ S·m⁻¹ (optionally less than 10⁻⁸ S·m⁻¹). Accordingly, an electric conductor, or a material (or coating) having an electric conductivity is understood to be a material which has an electrical conductivity of preferably at least 10 S·m⁻¹, furthermore preferably at least 10³ S·m⁻¹ (at room temperature of in particular 25° C.).

The substrate can be made from a material which foams and/or melts at a temperature of below 500° C., preferably below 200° C.

The polymer layer, or the polymer layers, respectively, can be (electrically) contacted by way of at least one metal structure, preferably an (in particular bent) metal sheet, preferably a copper sheet, and/or a metal strip and/or a metal wire and/or a metal mesh.

Alternatively or additionally, the metal structure (or corresponding electrodes, respectively) can be, for example, printed onto the substrate and/or the polymer layer, and/or be applied by vapour deposition and/or embossing and/or by coating.

The (optionally carbon-containing) polymer layer, or the (optionally carbon-containing) polymer layers, respectively, and/or a corresponding paste for the production thereof, can comprise at least one polymer (as an in particular crystalline binding agent), preferably based on at least one olefin; and/or at least one copolymer from at least one olefin and at least one monomer which can be copolymerized with the former, for example ethylene/acrylic acid and/or ethylene/ethyl acrylate and/or ethylene/vinyl acetate; and/or at least one polyalkenamer (polyacetylene or polyalkenylene) such as, for example, polyoctenamer; and/or at least one, in particular melt-deformable, fluoropolymer such as, for example, polyvinylidene fluoride and/or copolymers thereof.

The polymer layer, or the polymer layers, are preferably printed onto the (respective) substrate (for example by screen printing) or are applied thereto by a squeegee.

In general, the polymer layer(s) can have a continuous area (without interruptions) or be structured, for example have gaps (breakthroughs) or clearances.

A footprint of the respective heating element (preferably of a plurality or all of the heating elements) can be polygonal, in particular quadrangular, preferably rectangular or oval, in particular elliptic, preferably round (so as to be circular).

At least one intermediate space (optionally a plurality or all of the intermediate spaces) can be delimited by (precisely) two or more heating elements.

A cross section of the intermediate space (in general the fluid duct) can be polygonal, in particular quadrangular, preferably rectangular or oval, in particular elliptic, preferably round (so as to be circular).

A cross section within an intermediate space (fluid duct) can be variable or consistent (across the length of said intermediate space). Cross sections of dissimilar intermediate spaces or fluid ducts, respectively (thus intermediate spaces or fluid ducts, respectively, which are not configured by the same pair of the same group of heating elements) can also deviate from one another or be identical. For example, cross sections of the intermediate spaces or fluid ducts, respectively, can be configured so as to be slot-shaped (in particular as rectangular slots).

The respective polymer layer (of at least one of the heating elements, preferably of a plurality or all of the heating elements) can (at least on average) be thinner than the respective substrate, for example thinner by the factor 1.1, furthermore preferably by the factor 1.5.

In principle, the term “conductive” in terms of the conductive components of the heating apparatus is understood to be an abbreviation of “electrically conductive”.

The (respective) polymer layer is preferably a conductive layer displaying a PTC behaviour.

The heating apparatus is preferably conceived for an operation in the low-voltage range (for example <100 Volt or <60 Volt).

The heating apparatus can be conceived for an operation with DC and/or AC and/or PWM.

The substrate, or the substrates, respectively, can be configured as a plate, in particular a plastics material plate, and/or have a thickness of at least 0.1 mm, preferably at least 0.5 mm, furthermore preferably at least 1.0 mm and/or at most 5.0 mm, furthermore preferably at most 3.0 mm. The respective thickness is in particular an average thickness or a thickness of the largest region having a consistent thickness.

A (layer) thickness of the respective polymer layer can be <1 mm, preferably <0.5 mm, furthermore preferably <0.2 mm.

The first and/or the second polymer layer and/or the substrate (or the substrates, respectively) can be configured so as to be at least substantially planar. Should elevations (recesses) be provided, said elevations (recesses) can be less than 10% of an (average) thickness of the respective coating, or of the respective substrate.

A sum of the cross sections of fluid ducts, in particular of intermediate spaces between the heating elements) can be at least two times, preferably at least four times, the sum of the cross sections of the heating elements (in particular when viewed transversely to the fluid flow direction, or transversely to the width direction, respectively).

The proportion of the conductive components, or of the carbon proportions, respectively, in the polymer layer of at least one heating element (preferably of a plurality or all of the heating elements) can be configured such that said proportion enables a current flow (for example in the form of particles, wherein the particles are in corresponding physical contact or lie close to one another).

A diameter of the intermediate space between the first and the second heating element can be larger than a thickness of the first and/or the second heating element.

The (respective) polymer layer is preferably in contact with the (respective) substrate across at least 20%, furthermore preferably at least 50%, even more preferably at least 80% of a surface of the substrate that faces the polymer layer. On account thereof, heat can be transmitted effectively by way of the substrate (which in this instance serves as a further heat exchanger).

The object mentioned above is furthermore achieved by a vehicle, in particular a motor vehicle, comprising the (electric) heating apparatus above.

Further embodiments are derived from the dependent claims.

The disclosure will be described hereunder by means of exemplary embodiments which will be explained in more detail by means of the appended figures in which:

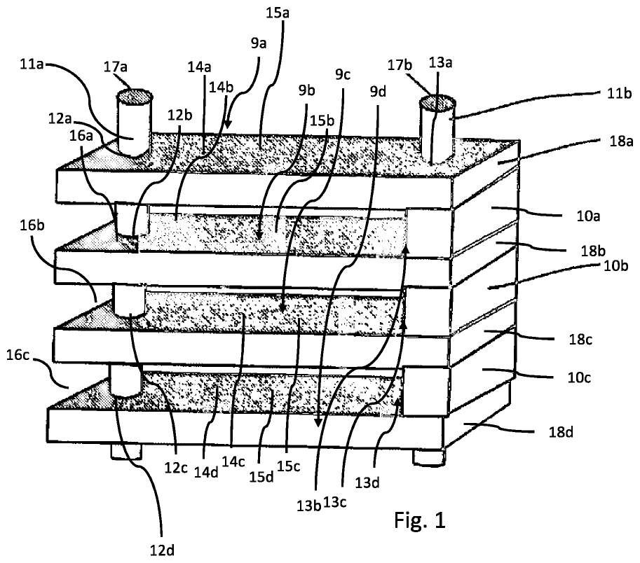

FIG. 1 shows a schematic oblique view of an electric air heating apparatus according to the disclosure;

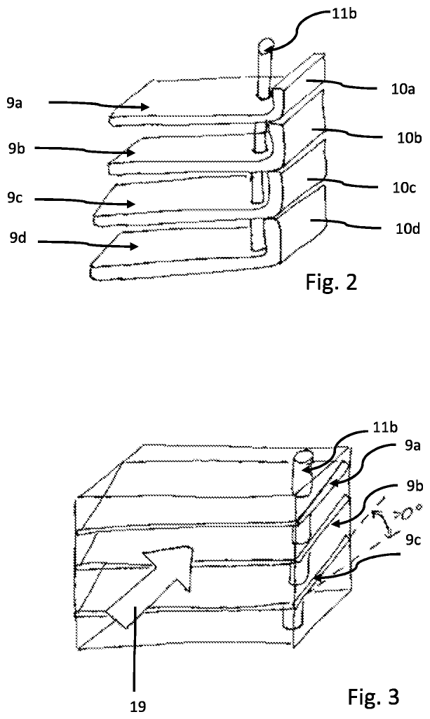

FIG. 2 shows a schematic oblique view of an electric air heating apparatus according to one further embodiment of the disclosure; and

FIG. 3 shows a schematic oblique view of an electric air heating apparatus according to one further embodiment of the disclosure.

The same reference signs are used for identical and functionally equivalent parts in the description hereunder.

FIG. 1 shows a schematic oblique view of an air heating apparatus according to the disclosure. The electric air heating apparatus has a plurality of (presently specifically four, this however not being mandatory) heating elements 9a to 9d. Corresponding intermediate spaces 16a to 16c are configured between the heating elements. Air can flow through said intermediate spaces for said air to be heated. The individual heating elements 9a to 9d are furthermore mutually spaced apart by spacers 10a, 10b, 10c that are disposed within the intermediate spaces 16a to 16c. precisely one spacer 10a, 10b, 10c is shown for each intermediate space 16a, 16b, 16c in FIG. 1. However, it is conceivable, for example, for two or more spacers to be provided. For example, a corresponding spacer can also be provided on an opposite periphery of the respective intermediate space 16a to 16c (on the left periphery in FIG. 1). The spacers are preferably from a conductive material (in particular metal).

Furthermore shown are positioning elements 11a, 11b. The positioning elements form in particular guide pins and penetrate (in the present exemplary embodiment all of the) heating elements 9a to 9d, or openings 12a to 12d and 13a to 13d of said heating elements 9a to 9d, respectively. Precisely two positioning elements 11a, 11b are provided in the present exemplary embodiment (this not being mandatory).

In the embodiment, both (not shown in detail) a (conductive) polymer layer 14a to 14d and corresponding electrodes 15a to 15d provided for contacting are printed on (in the present case on only one, optionally both) surface(s) of a respective substrate 18a to 18d. Apart from the printed electrodes, contacting preferably takes place by way of the (conductive) positioning elements 11a, 11b (preferably from metal) and the (conductive) spacers (contact pads) 16a to 16c (preferably from metal).

The positioning elements preferably are of a strip shape or a rod shape, respectively. A cross section can be rectangular, in particular square.

The positioning elements 11a, 11b preferably has a (round) rod shape and can have a round (circular) cross section.

The electric air heating apparatus is contacted by way of the terminals 17a, 17b.

FIG. 2 shows a schematic oblique view of an electric air heating apparatus according to one further embodiment of the disclosure. In the case of this embodiment, spacers 10a to 10d (which are bent upwards or run in a kinked manner, respectively) form an integral (monolithic) structure having the heating elements 9a to 9d.

FIG. 3 shows a schematic oblique view of an electric air heating apparatus according to one further embodiment of the disclosure. In the case of this embodiment, the heating elements 9a to 9d run at an angle of more than 0°, for example between 20 and 45°, (or so as to be at an attitude, respectively) in relation to a primary flow direction of the inflowing fluid according to arrow 19.

It is to be pointed out here that all parts described above are claimed to be relevant to the disclosure individually and in each combination, in particular in terms of the details illustrated in the drawings. Modifications thereof are well known to the person skilled in the art.

### LIST OF REFERENCE SIGNS

9a to 9d Heating element
10a to 10d Spacer
11a, 11b Positioning element
12a to 12d Opening
13a to 13d Opening
14a to 14d Polymer layer
15a to 15d Electrical connector structure
16a to 16c Intermediate space
17a, 17b Terminals
18a to 18d Substrate
19 Arrow

1. Electric heating apparatus for a motor vehicle, comprising a first heating element and at least one second heating element, wherein the heating elements comprise in each case one substrate and one polymer layer which contains a polymer component and a conductive component,
wherein an intermediate space through which fluid is capable of passing for heating said fluid is configured between the heating elements, wherein the heating elements are connected to one another by one or a plurality of spacer(s) disposed therebetween, and/or one or more positioning element(s) that penetrate (a) respective clearance(s) and/or openings of the heating elements.

2. Heating apparatus according to claim 1,
wherein
the first and/or the second heating element extend(s) at least substantially along a fluid flow direction and/or extend(s) at an angle in relation to the air flow direction.

3. Heating apparatus according to claim 1,
wherein
the respective polymer layer is printed in particular onto the substrate, and/or
electrical connector structures are printed onto the substrate or the polymer layer, respectively.

4. Heating apparatus according to claim 1,
wherein
at least three heating elements having corresponding intermediate spaces are provided.

5. Heating apparatus according to claim 1,
wherein
the component is a carbon component and is present in particle form and/or as a structure, and/or
the carbon component is present in the form of carbon black and/or graphite and/or
graphene and/or carbon fibres and/or carbon nanotubes,
and/or
the polymer component is configured in the form of an electrically insulating polymer component and/or comprises a first polymer sub-component based on ethylene acetate or ethylene acetate copolymer and/or ethylene acrylate or ethylene acrylate copolymer,
and/or
a second polymer sub-component based on polyolefin, in particular polyethylene and/or polypropylene, and/or polyester and/or polyamide and/or fluoropolymer.

6. Heating apparatus according to claim 1,
wherein
the heating elements are electrically wired in parallel.

7. Heating apparatus according to claim 1,
wherein
the spacers are an integral component part of the heating elements.

8. Method for producing an electric heating apparatus, according to claim 1, comprising a first heating element and at least one second heating element, wherein the heating elements comprises in each case one substrate and one polymer layer which contains a polymer component and a conductive component wherein an intermediate space through which fluid is capable of passing for heating said fluid is configured between the heating elements, wherein the heating elements are stacked on top of one another and/or are mutually spaced apart by spacers disposed between said heating elements, and/or wherein conductive, positioning elements are guided through the heating elements.

9. Method according to claim 8,
wherein
spacers of dissimilar sizes are provided and at least one spacer of a specific size is/are selected from said spacers, and/or positioning elements of dissimilar sizes are provided and at least one positioning element of a specific size is/are selected from said positioning elements.

10. Method according to claim 8,
wherein
the polymer layer and/or at least one electrical connector element is/are imprinted.

11. Kit for producing a heating apparatus according to claim 1, comprising a multiplicity of heating elements, wherein the heating elements comprise in each case one substrate and one polymer layer, which contains a polymer component and a conductive component wherein an intermediate space through which fluid can flow for heating said fluid is capable of being configured between the heating elements, wherein the heating elements are capable of being connected to one another in a modular manner such that a second number of heating elements can be added to or removed from a first number of heating elements that are connected to one another.

12. Kit according to claim 11,
wherein
the kit comprises spacers and/or positioning elements of dissimilar sizes, in particular lengths and/or thicknesses.

13. Method for operating a heating apparatus according to claim 1, wherein fluid flows through the at least one intermediate space and is heated herein.

14. Motor vehicle including a heating apparatus according to claim 1, for heating air or a liquid in an interior space of the motor vehicle

15. Electric heating apparatus according to claim 1 wherein the substrate is an insulating substrate, the conductive component is carbon component and the spacer(s), and/or the positioning element(s) are conductive.

16. Electric heating apparatus according to claim 1, wherein the fluid is liquid or air

17. Heating apparatus according to claim 2, wherein the angle is less than or equal to 90° and more than 0°.

18. Heating apparatus according to claim 2, wherein the angle is less than or equal to 90° and more than 10°.

19. Method according to claim 8 wherein the substrate is an insulating substrate, the conductive component is carbon component and the spacer(s), and/or the positioning element(s) are conductive.

20. Kit according to claim 11, wherein the substrate is insulating, the conductive component is a carbon component, and wherein the heating elements are connected to one another by means of conductive spacers that are disposed between the heating elements, and/or by means of conductive positioning elements that penetrate the heating elements.
